(19) United States
(12) Patent Application Publication
(10) Pub. No.: US 2012/0081340 A1
(43) Pub. Date: Apr. 5, 2012

(54) DRIVER AND DISPLAY DEVICE HAVING THE SAME

(75) Inventor: Sang Rok LEE, Seoul (KR)

(73) Assignee: NEX-I SOLUTION. CO., LTD, Chungcheongbuk-Do (KR)

(21) Appl. No.: 13/251,250

(22) Filed: Oct. 1, 2011

(30) Foreign Application Priority Data
Oct. 4, 2010 (KR) 10-2010-0096393

(51) Int. Cl. G09G 5/10; G09G 5/00

(52) U.S. Cl. 345/206; 345/212; 345/690

(57) ABSTRACT

Provided are a column driver and a display device including the same. The column driver includes a selection control unit configured to divide an n-bit image data into a k-bit sub data and an m-bit sub data such that k+m=n, and generate a selection control signal using the k-bit sub data and the m-bit sub data, a counter configured to receive an image control signal and generate an m-bit data, a conversion unit configured to receive the m-bit data from the counter and convert the m-bit data into a plurality of image data of different voltage ranges, and a selection unit configured to select and transfer an output signal of the conversion unit in response to the selection control signal

### CROSS-REFERENCE TO RELATED APPLICATION

This application claims priority to Korean Patent Application No. 10-2010-0096393 filed on Oct. 4, 2010 and all the benefits accruing therefrom under 35 U.S.C. §119, the contents of which are incorporated by reference in their entirety.

### BACKGROUND

The present disclosure relates to a display device, and more particularly, to a driver capable of improving an operation speed and a display device having the same.

Recently, liquid crystal displays (LCDs) are widely spread and used for display terminals of office automation (OA) apparatuses as well as small-sized display devices. An LCD includes a display panel where a liquid crystal layer is formed between a pair of insulating substrates at least one of which is comprised of a transparent substrate. In a display panel, a plurality of pixels is arranged in a matrix form, and each pixel includes active elements such as a pixel electrode and a thin film transistor for selecting pixels. And, a driving circuit is connected to a display panel for selecting pixels and for displaying an image on the selected pixels. The driving circuit includes a row driver to select a row of pixels, a column driver to transfer image data to the selected pixels in row, and a display control unit for controlling the row and column drivers. Therefore, the pixel, where signals transferred through the row and column drivers from the display control unit cross each other, is selected to display an image.

Meanwhile, a liquid crystal projector as a display device adopting an LCD has been commercialized. The liquid crystal projector projects the image of a liquid crystal panel onto a screen by illuminating light from a light source to the liquid crystal display panel. Among various types of LCDs, driving circuit integrated LCDs have been known, in which a driving circuit to drive a pixel array is also formed on a substrate where the pixel electrode is formed. In addition, liquid crystal on silicon (LCOS) technology has been known, in which a pixel array and a driving circuit are formed on a semiconductor substrate instead of an insulating substrate.

In an LCD, a column driver includes a Digital to Analog Converter (DAC), an amplifier (or a buffer), and the like to sequentially supply image data to a display panel. The DAC receives gray-scaled digital data of red (R), green (G), and blue (B) corresponding to the image data, converts the received data into an analog voltage, and outputs the analog voltage. The amplifier amplifies the analog voltage generated from the DAC and outputs the amplified voltage to the display panel.

However, in the case of a column driver of a related art LCD, there is a limitation that a time delay occurs while an amplifier performs an amplifying operation. That is, a related art column driver includes at least one DAC and amplifier, and due to this configuration, it takes a predetermined time to amplify inputted image data to a predetermined analog voltage. Generally, a time needed for amplification increases as capacitance load of an output terminal of an amplifier becomes large. Accordingly, the output of a signal is delayed, and thus driving pixels of a display panel is delayed so that image display is also delayed. As a result, an image is defectively displayed, or there is a limitation of a displayable resolution.

### SUMMARY

The present disclosure provides a driver and a display device including the same, capable of preventing image display defects due to delay of image data amplification and preventing a resolution of an image from being limited due to delay time during amplification or buffering of data.

The present disclosure also provides a driver and a display device capable of preventing image display defects or image resolution decrease due to the amplification delay of an amplifier.

The present disclosure also provides a driver and a display device capable of improving operation speed by dividing at least one of a DAC and an amplifier into plural components and differently configuring amplification voltage range of an amplifier, thereby reducing amplification time.

In accordance with an exemplary embodiment, a column driver includes a selection control unit configured to divide an n-bit image data into a k-bit sub data and an m-bit sub data such that k+m=n, and generate a selection control signal using the k-bit sub data and the m-bit sub data; a counter configured to receive an image control signal and generate an m-bit data; a conversion unit configured to receive the m-bit data from the counter and convert the m-bit data into a plurality of image data of different levels; and a selection unit configured to select and transfer an output signal from the conversion unit according to the selection control signal.

The selection control unit may include a shift register and latch configured to receive and latch the n-bit image data; a decoder configured to decode the k-bit sub data from the latched n-bit image data, and generate a plurality of output signals; and a comparator configured to compare the m-bit sub data from the latched n-bit image data with the m-bit data from the counter.

The decoder and the comparator may be configured in plural corresponding to the number of image data lines through which image data are supplied to pixels.

A control unit configured to convert an n-bit data in series into a parallel data and apply the parallel data to a shift register and latch may be further included.

The conversion unit may include at least one lookup table configured to store a data set to convert gray-scaled image data, and receive the m-bit data from the counter; and a plurality of Digital to Analog Converters (DACs) configured to convert and amplify an image data whose gray level is changed according to the data set stored in the lookup table to an analog signal, wherein the number of the DACs corresponds to the number of bits of the k-bit sub data, wherein each of the DACs may include an amplifier, and the amplifiers amplify voltages of different ranges.

The conversion unit may include at least one lookup table configured to store a data set to convert gray-scaled image data, and receive the m-bit data from the counter; a plurality of DACs configured to convert and amplify an image data whose gray level is changed according to the data set stored in the lookup table to an analog signal, wherein the number of the DACs corresponds to the number of bits of the k-bit sub data; and a plurality of amplifiers configured to amplify voltages of different levels outputted from each of the DACs.

Each of the amplifiers amplifies a divided voltage range from a maximum amplification voltage range, wherein a maximum amplification voltage of one amplifier is a starting amplification voltage of a next amplifier.

The selection unit may include a plurality of switch blocks configured to select an output signal of the DAC or the amplifier in response to an output signal of the decoder; and a plurality of switches configured to respectively select signals transferred through the switch blocks in response to an output signal of the comparator.

Each of the switch blocks may include a plurality of switches whose number corresponds to the number of the DAC or the amplifier.

The switch may be configured in plural corresponding to the number of image data lines supplying image data to pixels.

In accordance with another exemplary embodiment, a column driver includes: a shift register and latch configured to receive and latch n-bit image data; a plurality of decoders configured to decode a k-bit sub data from the latched n-bit image data, and generate a plurality of output signals; a counter configured to receive an image control signal and generate an m-bit data; a plurality of comparators configured to compare the m-bit sub data from the latched n-bit image data with the m-bit data from the counter; at least one lookup table configured to store a data set to convert gray-scaled image data; a plurality of Digital to Analog Converters (DACs) configured to convert an image data whose gray level is changed according to the data set stored in the lookup table to an analog signal, wherein the number of the DACs corresponds to the number of bits of the k-bit sub data; a plurality of amplifiers configured to amplify voltages of different ranges outputted from each of the DACs; and a selection unit configured to transfer output signals of the amplifiers in response to the output signals of the decoder and the comparator.

In accordance with yet another exemplary embodiment, a display device includes: a display panel including a display unit where a plurality of pixels are arranged in a matrix form, a row driver configured to supply a scanning signal to select a row of pixels, and a column driver configured to supply image data to the selected pixels in row; and a display control unit configured to supply a control signal for driving the display panel and the image data, wherein the column driver includes: a selection control unit configured to divide an n-bit image data into a k-bit sub data and an m-bit sub data such that k+m=n, and generate a selection control signal using the k-bit sub data and the m-bit sub data; a counter configured to receive an image control signal and generate an m-bit data; a conversion unit configured to receive the m-bit data from the counter and convert the m-bit data into a plurality of image data of different voltage ranges; and a selection unit configured to select and transfer an output signal of the conversion unit in response to the selection control signal.

The display unit, the row driver, and the column driver may be provided on the same substrate.

The display unit may be provided on a substrate, and the row driver and the column driver may be connected to the display unit.

The display unit, the row driver, the column driver, and the display control unit may be provided on the same substrate.

The row driver may be provided at one side of the display unit, and the column driver may be provided at the other side of the display unit intersecting the row driver at right angles.

A row driver may be additionally provided at the opposite side of the said row driver across the display unit.

A column driver may be additionally provided at the opposite side of the said column driver across the display unit.

### BRIEF DESCRIPTION OF THE DRAWINGS

Exemplary embodiments can be understood in more detail from the following description taken in conjunction with the accompanying drawings, in which:

FIG. 1 is a block diagram illustrating a display device in accordance with an exemplary embodiment;

FIG. 2 is a block diagram illustrating a column driver in accordance with an exemplary embodiment;

FIGS. 3A and 3B are graphs illustrating amplification voltage ranges of a related art amplifier and an amplifier in accordance with an exemplary embodiment;

FIGS. 4 to 6 are block diagrams illustrating column drivers in accordance with other exemplary embodiments; and

FIGS. 7 to 11 are block diagrams illustrating display devices in accordance with other exemplary embodiments.

### DETAILED DESCRIPTION OF EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

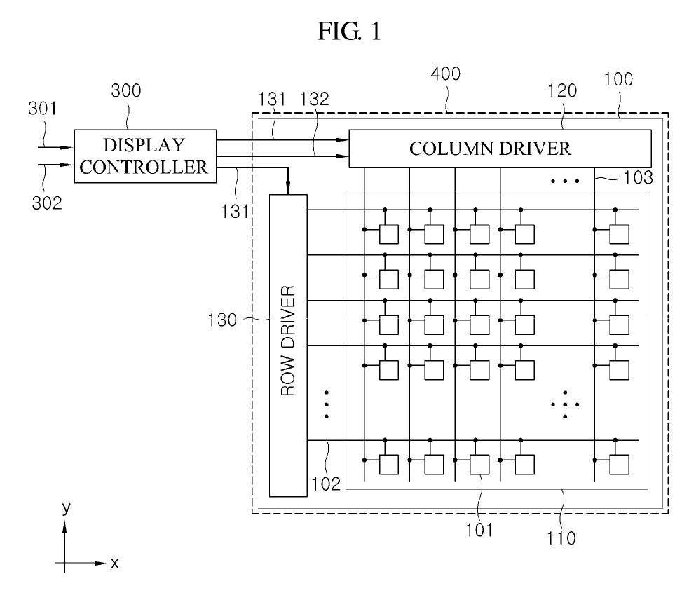

FIG. 1 is a schematic block diagram illustrating a display device in accordance with an exemplary embodiment.

Referring to FIG. 1, the display device in accordance with the exemplary embodiment includes a display panel 100 configured to display an image and a display controller 300 configured to control the operation of the display panel 100. Furthermore, the display panel 100 includes a display unit 110, a column driver 120, and a row driver 130.

The display panel 100 includes a display unit 110 having a plurality of pixels 101 arranged in a matrix form, a column driver 120 configured to supply image data to the display unit 110, and a row driver 130 configured to select a row of pixels 101 on which the image is to be displayed. Herein, the display unit 110, the column driver 120, and the row driver 130 may be formed on the same substrate 400. Also, the display unit 110 may be formed on a substrate, and the column driver 120 and the row driver 130 may be provided such that they are connected to the display unit 110 at an outer side of the display unit 110. In the display unit 110, pixel electrodes and a counter electrode are disposed facing each other, and a liquid crystal layer is provided therebetween to thereby provide the plurality of pixels 101. An image is displayed using the fact that the alignment direction of liquid crystal molecules are changed thereby changing the birefringence of the liquid crystal layer if a voltage is applied to a pixel electrode and a counter electrode to induce an electric potential difference therebetween. The plurality of pixels 101 are respectively disposed at the intersections of a plurality of scanning signal lines 102 extending in one direction, e.g., horizontal direction (x-direction), and a plurality of image signal lines 103 extending in another direction, e.g., vertical direction (y-direction), and an active element such as a transistor to select a pixel is provided in each of the pixels 101.

The display controller 300 is connected to an external device (not shown) such as a personal computer through an external control signal line 301. The display controller 300 receives external control signals from the outside through the external control signal line 301, and generates control signals controlling the column driver 120 and the row driver 130 using the external control signal. A display signal line 302 is connected to the display controller 300, and the display controller 300 thus receives display data from an external apparatus. The display data is transmitted in a predetermined order so as to form an image displayed on the display panel 100, and received by the display controller 300. For example, pixel data of the first row are sequentially transmitted from an external apparatus in the right direction from the pixel 101 placed at the left top corner of the display panel 100. Then, pixel data of the respective rows are sequentially transmitted from top to bottom through the external apparatus. The display controller 300 generates image data based on display data, and supplies the image data to the column driver 120 on the timing when the display panel 100 displays image. To this end, the display controller 300 transfers the control signal to the column driver 120 and the row driver 130 through a control signal line 131, and transfers image data to the column driver 120 through an image data transmission line 132. That is, the column driver 120 and the row driver 130 are controlled and driven by the display controller 300, and the image data are transferred to the display unit 110 through the column driver 120. Meanwhile, although FIG. 1 illustrates the image data transmission line 132 singly, the image data transmission line 132 may be provided in plural.

The column driver 120 is provided in a periphery of the display unit 110, for example, at one side of the display unit 110 in a vertical direction (y-direction). The plurality of image data lines 103 are arranged in a vertical direction (y-direction) from the column driver 120. The image data line 103 is connected to the plurality of pixels 101, and thus transfers the image data to the pixel 101. That is, the image data generated from the display controller 300 is transferred to the column driver 120 through the image data transmission line 132, and then transferred to the display unit 110 through the image data line 103.

The row driver 130 is provided in a periphery of the display unit 110, for example, at one side of the display unit 110 in a horizontal direction (x-direction). The plurality of scanning signal lines 102 are arranged in a horizontal direction (x-direction) from the row driver 130. The scanning signal line 102 is connected to the plurality of pixels 101, and the scanning signal to turn on or off an active element such as a thin film transistor provided in the pixel 101 is transferred through the scanning signal line 102. That is, the control signal generated from the display controller 300 is transferred to the row driver 130 through the control signal line 131, and then transferred to the display unit 110 through the scanning signal line 102, thereby turning on or off a switching element in the selected pixel 101. Therefore, the pixels 101 are selected by the row driver 130, and the image data are transferred to the selected pixels 101 through the column driver 120 thereby displaying an image.

Meanwhile, although power supply lines of circuits are omitted, needed voltages are supplied to each circuit such as the display panel 100 from the display controller 300.

A method of operating the display device in accordance with the exemplary embodiment will be briefly described.

If a display timing signal is triggered after the display controller 300 receives a control signal (e.g., a vertical synchronizing signal) indicating a display start, which is transferred through the external control signal line 301 from the outside, the display controller 300 outputs a start pulse to the row driver 130 through the control signal line 131. Thereafter, the display controller 300 outputs a shift clock to the row driver 130 so as to sequentially select the scanning line 102 every horizontal synchronizing signal. The row driver 130 selects the scanning line 102 according to the shift clock and outputs a scanning signal to the scanning signal line 102. That is, the row driver 130 outputs a sequential signal selecting the scanning signal line 102 for one horizontal scanning time from top to bottom.

Also, if the display timing signal is triggered, the display controller 300 regards this input as a display start in a horizontal direction and outputs image data to the column driver 120. The image data are sequentially fed from the display controller 300, and registers in the column driver 120 outputs a timing signal according to the shift clock transferred from the display controller 300. The timing signal denotes the timing when the received image data is outputted to each image data line 103.

In the case that image data supplied from the display controller 300 are analog data, the column driver 120 receives the image data and outputs them to each image data line 103. The display controller 300 outputs synchronized image data when the timing signal is inputted, for the column driver 120 to receive desired image data. The column driver 120 samples and holds the image data (analog data) synchronized with the timing signal, i.e. an analog voltage (gray-scaled analog voltage), and outputs the stored voltage (gray-scaled analog voltage) to the image data line 103. The voltage (gray-scaled analog voltage) outputted to the image data line 103 is written to a pixel electrode of the pixel 101 according to the timing when the scanning signal is outputted from the row driver 130.

Meanwhile, in the case that image data are digital data, the column driver 120 has registers to receive and store the image data (digital data) for each data line 103, and the latch latches the image data if the timing signal is inputted. analog voltages (gray-scaled analog voltages) corresponding to digital data are supplied to the column driver 120, and the column driver 120 selects an analog voltage (gray-scaled analog voltage) according to the latched image data (digital data) and outputs the selected analog voltage (gray-scaled analog voltage) as image data to the image data line 103.

Therefore, a pixel 101 is selected in response to the scanning signal generated by the row driver 130 and transferred through the scanning signal line 102, and the image data generated by the column driver 120 and supplied through the image data line 103 are transferred to the pixel so that an image is displayed on the selected pixel 101.

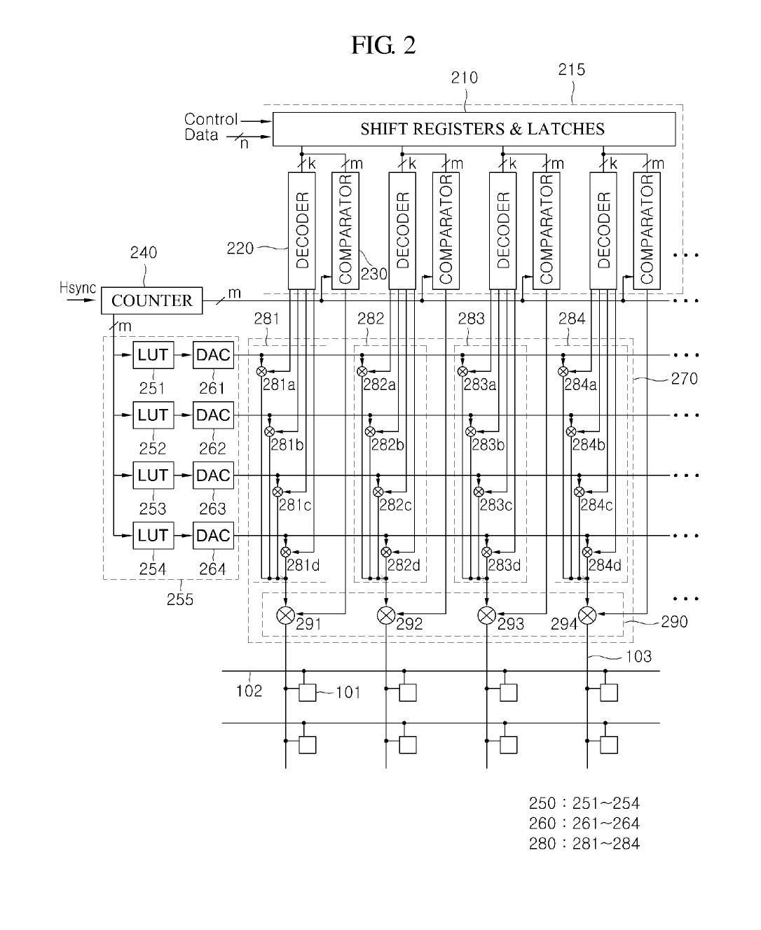

FIG. 2 is a block diagram illustrating a column driver in accordance with an exemplary embodiment.

Referring to FIG. 2, the column driver in accordance with the exemplary embodiment includes a selection control unit 215 configured to generate a selection control signal using a k-bit sub data from an n-bit image data; a conversion unit 255 including at least one lookup table 250 and a plurality of Digital to Analog Converters (DACs) 261 to 264 (referred to as 260) corresponding to the number of bits of the k-bit sub data to convert an m-bit data into an analog image data of different voltage levels; and a selection unit 270 configured to select an output signal of the conversion unit 255 in response to the selection control signal and transfer the selected signal to a selected pixel 101 through the image data line 103.

The selection control unit 215 may include shift registers and latches 210, a plurality of decoders 220, and a plurality of comparators 230. The shift registers and latches 210 receive control signals and serial n-bit image data from the display controller 300 and latch them. The decoders 220 receive a k-bit sub data divided from the data latched by the latches 210 and decode the received data. The comparators 230 receive an m-bit data divided from the data latched by the latches 210 and an m-bit data from a counter 240 and compare them. The conversion unit 255 may include at least one lookup table 250 and a plurality of DACs 260. The counter 240 receives an image control signal HSYNC and generates an m-bit data which sequentially increases or decreases. The lookup table 250 receives the m-bit data from the counter 240 and outputs digital image data corresponding to the received m-bit data. The DACs 260 convert a digital image signal into an analog signal such that the analog signal correspond to the digital data outputted from the lookup table 250. The selection unit 270 includes a plurality of switch blocks 281 to 284 (referred to as 280) each of which includes a plurality of switches, and a plurality of switches 290 to selectively transfer an output signal of the DAC 260 to the display unit 110 according to an output signal of the decoder 220 and an output signal of the comparator 230.

The shift registers and latches 210 receive control signals from the display controller 300 through the control signal line 131 and latch n-bit image data, transferred from the display controller 300 in response to the control signal. That is, the shift registers generate the timing signal by sequentially shifting control signals, and the latches latch n-bit image data transferred from the display controller 300 in response to the timing signal. Herein, the latched n-bit data is divided into k-bit sub data and m-bit sub data such that k+m=n, and the k-bit sub data and the m-bit sub data are respectively inputted to the decoder 220 and the comparator 230. For instance, if the latched n-bit data is an 8-bit data, the 8-bit data is divided into an upper 2-bit data and a remaining 6-bit data. Then, the 2-bit sub data is inputted to the decoder 220, and the 6-bit sub data is inputted to the comparator 230. Herein, the 8-bit data may also be divided into a 3-bit sub data and a 5-bit sub data to be respectively inputted to the decoder 220 and the comparator 230, or may also be divided into a 4-bit sub data and a 4-bit sub data to be respectively inputted to the decoder 220 and the comparator 230.

The decoder 220 decodes the k-bit sub data divided from the latched n-bit data to generate a plurality of signals. Also, the decoder 220 may be configured in plural corresponding to the number of latched and sequentially outputted signals. Therefore, each decoder 220 decodes the k-bit sub data latched and sequentially inputted to thereby generate a plurality of signals. Meanwhile, the number of latched and sequentially outputted signals corresponds to the number of pixels 101 arranged in an x-direction (horizontal direction) of the display unit 110. Therefore, the number of decoders 220 may correspond to the number of pixels 101 arranged in an x-direction (horizontal direction) of the display unit 110. For instance, each decoder 220 decodes 2-bit sub data to generate 4 signals, decodes 3-bit sub data to generate 8 signals, or decodes 4-bit sub data to generate 16 signals. That is, according to the number of bits of k-bit sub data, 2^{k} signals are generated. Also, since the k-bit sub data relates to the number of DACs 260, not only the number of signals decoded and outputted from the decoder 220 but also the number of DACs 260 is increased as the number of bits of k-bit sub data is increased. That is, the number of DACs 260 satisfies 2^{k}. In the exemplary embodiment, it is assumed that the decoder 220 decodes a 2-bit sub data and outputs 4 signals for description. Output signals of the decoder 220 are supplied to the switch block 280 of the selection unit 270.

The comparator 230 is configured in plural corresponding to the number of decoders 220, and receives the m-bit sub data divided from the latched data and the m-bit data provided from the counter 240 to determine whether the two data are equal. That is, continuously supplied n-bit image data is received and latched by the shift registers and latches 210, and m-bit sub data from the latched n-bit image data is respectively supplied to the comparator 230. Then, the comparator 230 compares the m-bit sub data with the m-bit data from the counter 240. In the case that the two data are equal, i.e., they are the same image data, an output signal of the comparator 230 is generated and image data is supplied to a selected pixel 101. An output signal of the comparator 230 is supplied to the switch 290 of the selection unit 270, and the switch 290 is selected to be turned on when the two data are equal.

The counter 240 receives an inputted image control signal, generates m-bit data which sequentially increases or decreases, and transfers the m-bit data to the comparator 230. That is, the counter 240 inputs the same-bit data as the m-bit sub data divided from the data latched by the shift registers and latches 210 to the comparator 230. And, the counter 240 provides the m-bit data to a plurality of lookup tables 250.

A plurality of lookup tables 251 to 254 (referred to as 250) store modulation data to change a digital data into a higher resolution digital data in a table form, to display an image on a display device such as an LCD having nonlinear optical characteristics. Each of the lookup tables 250 stores different modulation data. For instance, the first lookup table 251 stores modulation data corresponding to grayscales ranging from 0 to 64, the second lookup table 252 stores modulation data corresponding to grayscales ranging from 65 to 127, the third lookup table 253 stores modulation data corresponding to grayscales ranging from 128 to 192, and the fourth lookup table 254 stores modulation data corresponding to grayscales ranging from 193 to 256. That is, modulation data corresponding to 256 grays is divided and stored in respective lookup tables 250. Therefore, the lookup tables 250 output modulated data corresponding to the data inputted by the counter 240. Also, according to the modulated data outputted through the lookup tables 250, the DACs 260 are driven to generate an analog data.

The DACs 260 respectively receive the modulated data from the lookup tables 250 and convert them into analog signals. The analog signals converted by the DACs 260 are supplied to the switch blocks 280. An amplifier is provided in each DAC 260. For each amplifier included in each DAC 260, a voltage amplification range is differently configured. For instance, an amplifier of the first DAC 261 amplifies from approximately 0 V to approximately 1.25 V, and an amplifier of the second DAC 262 amplifies from approximately 1.25 V to approximately 2.5 V. Similarly, an amplifier of the third DAC 263 amplifies from approximately 2.5 V to approximately 3.75 V, and an amplifier of the fourth DAC 264 amplifies from approximately 3.75 V to approximately 5.0 V. Therefore, since the amplification operation of each amplifier is restricted by the outputs of DACs 260 and the voltage range to be amplified by an amplifier of each DAC 260 is narrowed, an amplification time may be reduced, and thus an operation speed may become faster in comparison with a related art in which a single amplifier is provided to perform an operation of whole voltage range amplification. For instance, in accordance with the exemplary embodiment, since the DAC 260 is divided into four, and the amplification range of each amplifier in DAC 260 is approximately 1.25 V such that whole amplification voltage range is approximately 5 V, an amplification speed may be reduced, and thus an operation speed may be faster in comparison with a related art in which the amplification range of a single amplifier is approximately 5 V. Meanwhile, since k-bit data relates to the number of DACs 260, not only the number of output signals of the decoder 220 but also the number of DACs 260 is increased as the number of bits of k-bit data is increased. The number of amplifiers is also increased as the number of DACs 260 is increased. By configuring the voltage amplification range narrower by increasing the number of amplifiers, an operation speed may become faster.

The selection unit 270 selectively transfers outputs of the DACs 260 according to the output signals of the selection control unit 215, i.e., according to the output signals of the decoder 220 and the comparator 230. The selection unit 270 includes the plurality of switch blocks 280 each of which includes a plurality of switches configured to select the output signals of the DAC 260 according to the output signal of the decoder 220, and the plurality of switches 290 configured to transfer the output signal transferred through the switch block 280 to the pixel 101 through the image data line 103 according to the output signal of the comparator 230.

The switch blocks 280 are configured in plural corresponding to the number of decoders 220, and each of the switch blocks 280 includes a plurality of switches corresponding to the number of signals outputted from the decoders 220 and the number of DACs 260. For instance, the switch block 281 includes 4 switches 281a to 281d in the case that 4 signals are outputted from one decoder 220 and the number of DACs 260 is 4. That is, the switches 281a to 281d of the switch block 281 are respectively driven in response to output signals of the decoder 220, thereby transferring each output signal of the DACs 280 to the image data line 103. For instance, the output signal of the first DAC 261 is supplied to the switch 281a of the switch block 281 and a switch 282a of the switch block 282. Such a switch block 280 is driven in response to the output signal of the decoder 220, thereby selectively transferring an output signal of the DAC 260 to the switch block 290. That is, each of the plurality of switches of the switch block 280 is connected between the DAC 260 and the switch block 290 and driven in response to the output signal of the decoder 220.

Each of the switches 290 is driven in response to the output signal of the comparator 230, thereby transferring an output signal of the DAC 260 transferred through the switch block 280 to the pixel 101. That is, one pixel 101 is selected by the row driver 130, and image data are transferred to the selected pixel 101 through the image data line 103. The number of switches 290 corresponds to the number of image data lines 103 and the number of switch blocks 280.

A method of operating the above-described column driver in accordance with the exemplary embodiment will be described.

Firstly, the shift registers and latches 210 receive control signals and n-bit image data from the display controller 300 and latch them. The latches 210 sequentially latch and output the n-bit image data. The data outputted from the latches 210 is divided into a k-bit sub data and an m-bit sub data such that k+m=n. The k-bit sub data is fed to the decoders 220, and the m-bit sub data is fed to the comparators 230. The decoder 220 receives and decodes the k-bit sub data, and outputs 2^{k} numbers of signals. The comparators 230 receive the m-bit sub data divided from the data latched by the latches 220 and an m-bit data from the counter 240 and compares them.

Meanwhile, when an image control signal, HSYNC, from the display controller 300 is fed to the counter 240, the counter 240 sequentially generates an m-bit data and transfers the m-bit data to the comparators 230 and the lookup tables 250. The lookup table 250 outputs a modulated data, i.e. m+α bit data, corresponding to the m-bit data fed by the counter 240. The DACs 260 convert and amplify a digital signal to an analog signal according to the corresponding modulated data outputted from the lookup tables 250.

The switch block 280 transfers a signal outputted from the DAC 260 to the input switch 290 in response to the output signal of the decoder 220. Then, the switch 290 transfers the output signal of the switch block 280, i.e., a signal outputted from the DAC 260 and transferred through the switch block 280, to the image data line 103 in response to the output signal of the comparator 230. Therefore, image data are transferred to the selected pixel 101 of the display unit 110 through the image data line 103, and thus an image is displayed.

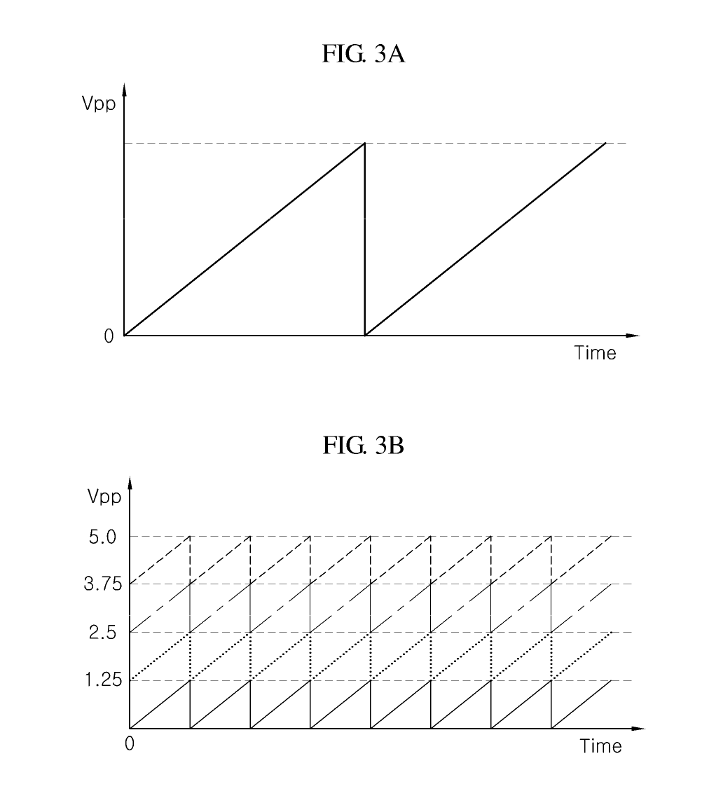

As described above, in the column driver in accordance with the exemplary embodiment, the DACs 260 are configured in plural, and the decoders 220 are configured to decode signals, whose number corresponds to the number of DACs 260 and output the decoded signals. The number of output signals of the decoder 220 and the number of DACs 260 are determined according to the number of bits of k-bit data divided from n-bit image data inputted and latched by the registers and latches 210. Since the DACs 260 are configured in plural, amplifiers in the DACs 260 are also configured in plural. Since a plurality of amplifiers is included, a voltage range to be amplified by each amplifier is divided. Therefore, an amplification time of an amplifier may be reduced, and thus an output time may be reduced improving an operation speed in comparison with a related art in which a single amplifier amplifies whole voltage ranges. FIG. 3A is a graph illustrating a relation between a voltage amplification range and an amplification time of a related art amplifier, and FIG. 3B is a graph illustrating a relation between voltage amplification ranges and an amplification time of an amplifier in accordance with the exemplary embodiment in which 4 DACs are used. As illustrated in FIG. 3A, it takes a long time to amplify a voltage to a power supply voltage Vpp using a single amplifier. However, as illustrated in FIG. 3B, by including 4 amplifiers and configuring differently amplification voltage range for each amplifier, the time needed for amplification may be reduced. Also, since the voltage amplification range of an amplifier is decreased, the circuit of an amplifier may be simply designed, and thus the size of an amplifier may be reduced.

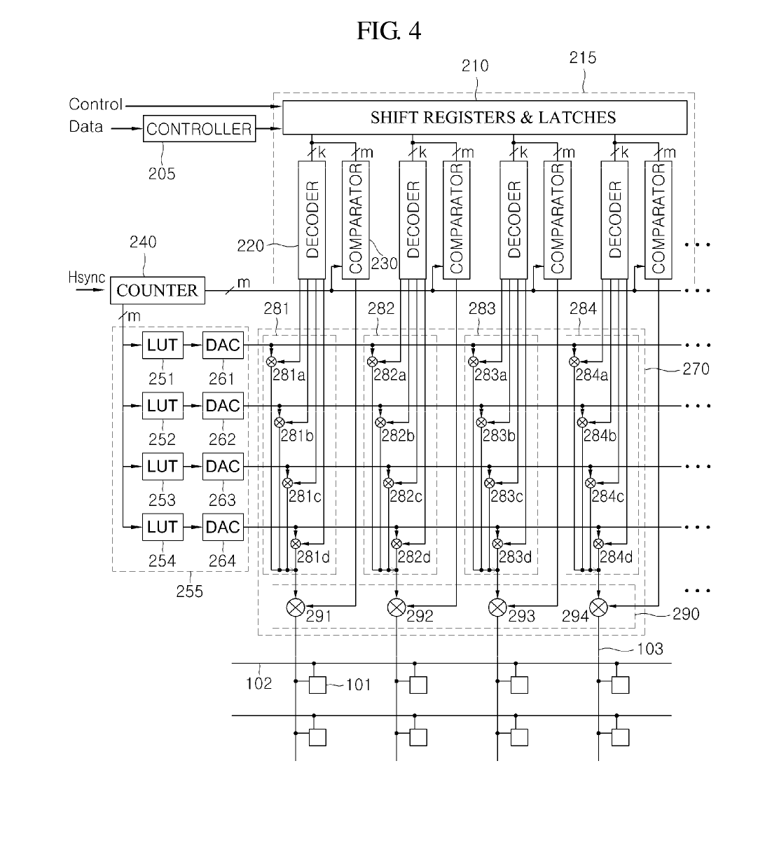

Meanwhile, although it has been described that an amplifier is included in the DAC 260, an amplifier may also be provided at the outside of the DAC 260, i.e., between the DAC 260 and the switch block 280, to amplify an output signal of the DAC 260. Of course, amplifiers may also be respectively provided at the outside and inside of the DAC 260. Column drivers in accordance with various exemplary embodiments are illustrated in FIGS. 4 to 6.

FIGS. 4 to 6 are block diagrams illustrating column drivers in accordance with other exemplary embodiments.

Referring to FIG. 4, in a column driver in accordance with another exemplary embodiment, a controller 205 is provided between the display controller 300 and the shift registers and latches 210. The controller 205 converts data fed in series from the display controller 300 into parallel data and applies the parallel data to the latch. That is, the shift registers sequentially shift, e.g., a control signal, CONTROL, such as a shift clock, thereby generating a timing signal. The latches latch n-bit parallel data transferred from the display controller 300 through the controller 205 in response to the timing signal and outputs the latched data.

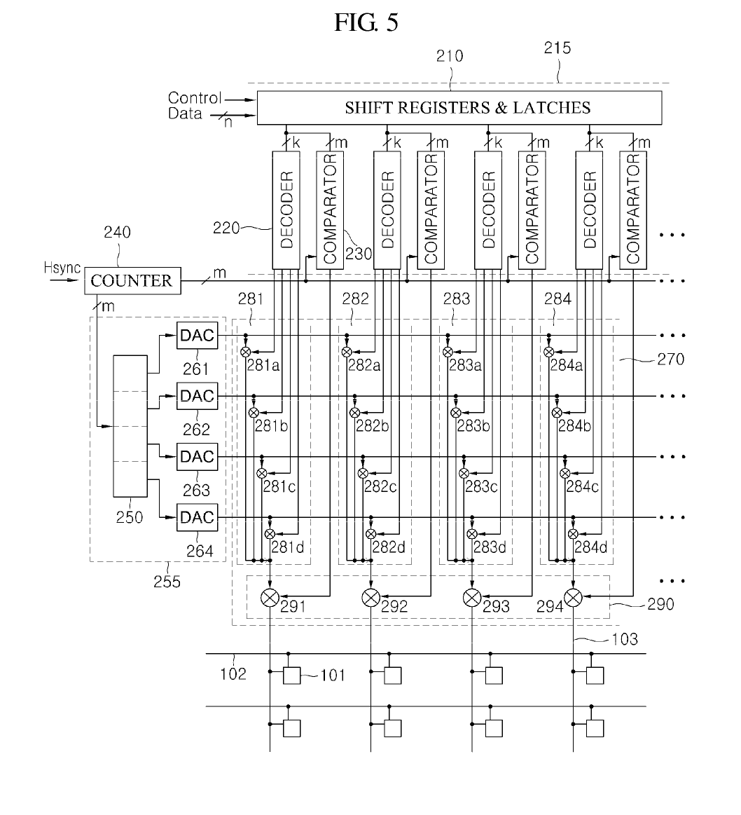

Meanwhile, referring to FIG. 5, in a column driver in accordance with still another exemplary embodiment, the lookup table 250 is configured singly, and the DACs 260 are selectively driven according to modulated data outputted through the lookup table 250. Herein, one lookup table 250 may be divided into a plurality of regions, and the DACs 260 may be driven according to modulated data outputted from each region.

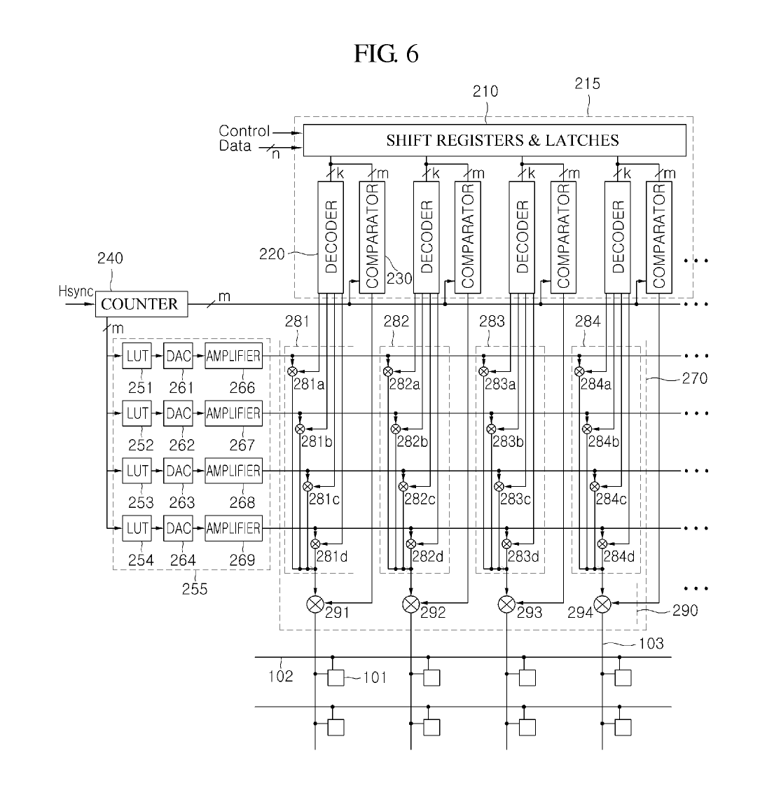

Further, referring to FIG. 6, in a column driver in accordance with yet another exemplary embodiment, a plurality of amplifiers 266 to 269 are respectively provided at output terminals of the DACs 260. Therefore, the amplifiers 266 to 269 respectively amplify output signals of the DACs 260 and transfer the amplified signals to the switch block 280. Herein, an amplifier may also be included in each DAC 260.

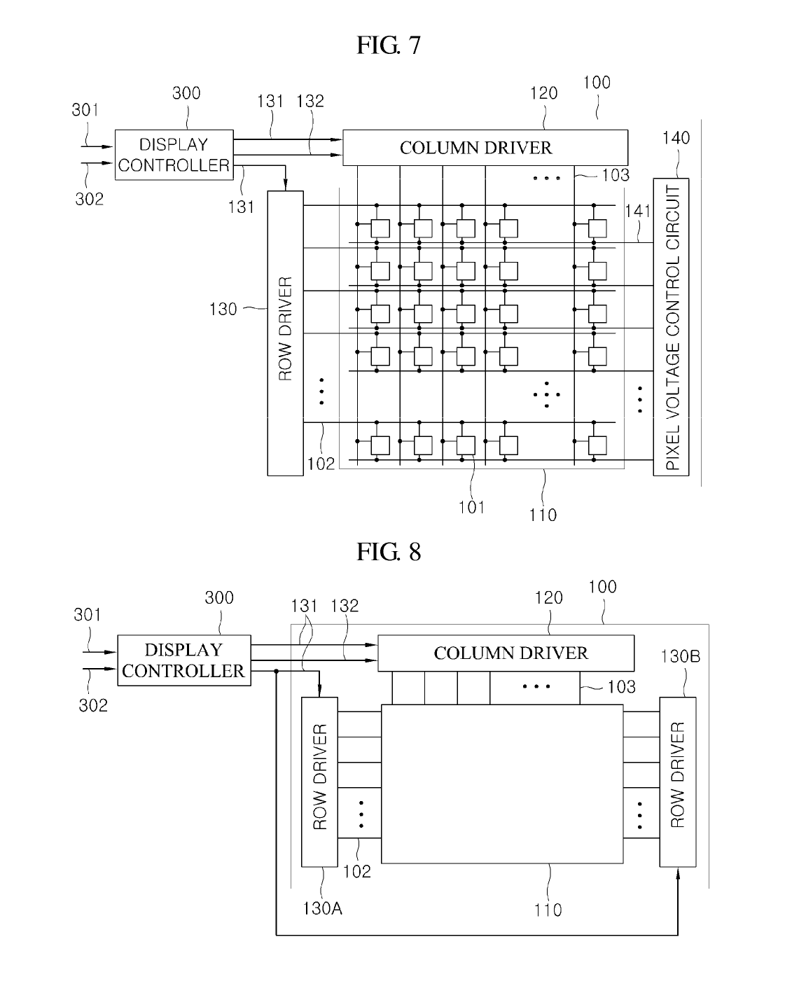

FIG. 7 is a block diagram illustrating a display device in accordance with another exemplary embodiment in which a pixel voltage control circuit 140 is provided.

Referring to FIG. 7, the display device in accordance with the other exemplary embodiment includes a display panel 100 and a display controller 300. The display panel 100 includes a display unit 110, a column driver 120, a row driver 130, and the pixel voltage control circuit 140.

The pixel voltage control circuit 140 is provided in a periphery of the display unit 110, for example, at the other side of the display unit 110 in a horizontal direction (x-direction). That is, the row driver 130 is arranged at one side of the display unit 110 in a horizontal direction, and the pixel voltage control circuit 140 is provided at the opposite side of the display unit 110 in a horizontal direction. The pixel voltage control circuit 140 receives a control signal from the display controller 300 through a control signal line 131 and supplies a signal for controlling the voltage of the pixel 101. To this end, a plurality of pixel voltage control lines 141 are extended from the pixel voltage control circuit 140 in a horizontal direction (x-direction). The signal for controlling the voltage of a pixel electrode is transferred through the pixel voltage control line 141. The pixel voltage control circuit 140 controls the voltage of an image signal written to a pixel electrode based on a control signal outputted from the display controller 300. A gray-scaled voltage written to a pixel electrode from the image signal line 103 has a certain potential difference from a reference voltage of a counter electrode. The pixel voltage control circuit 140 changes a potential difference between a pixel electrode and a counter electrode supplying a control signal to the pixel 101.

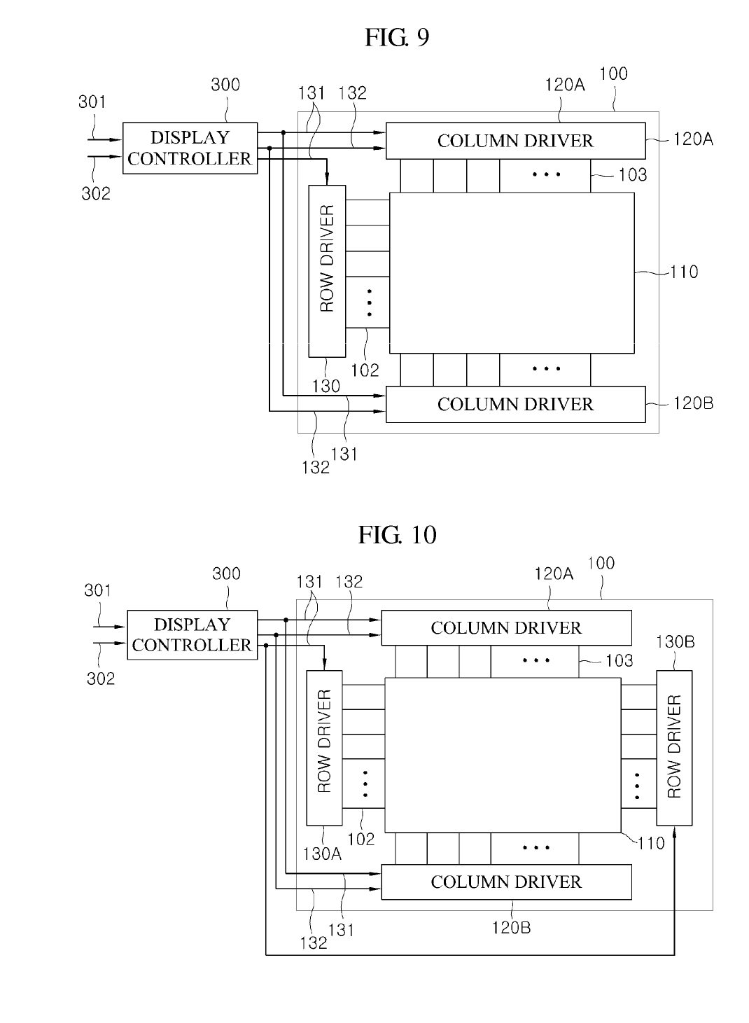

FIGS. 8 to 10 are block diagrams illustrating display devices in accordance with other exemplary embodiments. For improving chip production yield, row drivers 130A and 130B may be respectively provided at one side and the opposite side of the display unit 110 in a horizontal direction as illustrated in FIG. 8. For improving data processing speed, as illustrated in FIG. 9, column drivers 120A and 120B may be provided at one side and the opposite side of the display unit 110 in a vertical direction. As illustrated in FIG. 10, row drivers 130A and 130B may be respectively provided at one side and the opposite side of the display unit 110 in a horizontal direction, and column drivers 120A and 120B may be provided at one side and the opposite side of the display unit 110 in a vertical direction so that chip production yield and data processing speed may be improved.

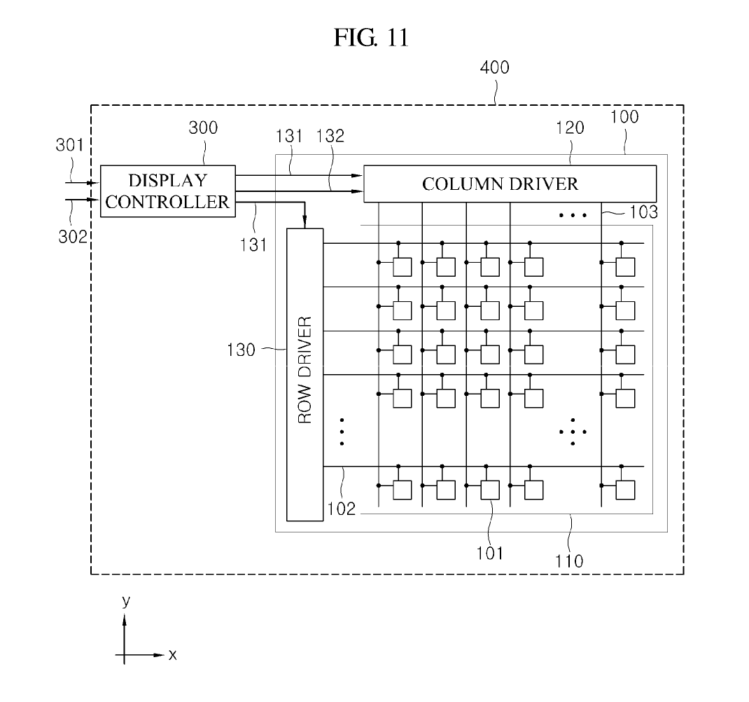

Meanwhile, although it has been described that the display unit 110, the column driver 120, and the row driver 130 are provided on the same substrate 400 constructing the display panel 100, and the display controller 300 is separately provided in accordance with the exemplary embodiments, the display controller 300 may also be provided on the same substrate 400 with the display unit 110, the column driver 120, and the row driver 130 as illustrated in FIG. 11.

A display device including the column driver in accordance with the exemplary embodiments may be used as a back plane of various display devices such as an LCOS, a Liquid Crystal Display (LCD), a Plasma Display Panel (PDP), a Field Emission Display (FED), and an Organic Light Emission Device (OLED) or may be used as a column driver chip at the outside.

In the column driver in accordance with the exemplary embodiments, a plurality of DACs, whose number is 2^{k} corresponding to the number of bits of k-bit sub data divided from n-bit image data are provided. Since a plurality of DACs are provided, an amplifier in the DACs or an amplifier configured to amplify an output signal of the DAC at a rear terminal of the DAC is also configured in plural. Also, an amplification voltage range is differently configured for each amplifier. For instance, in the case that the number of DACs is 4 and the number of the amplifiers is accordingly 4, if the amplifiers amplify approximately 5 V at maximum, each of the four amplifiers amplifies as much as approximately 1.25 V in four ranges of voltages (from approximately 0 V to approximately 1.25 V, from approximately 1.25 V to approximately 2.5 V, from approximately 2.5 V to approximately 3.75 V, from approximately 3.75 V to approximately 5 V).

Therefore, an amplification time of an amplifier can be reduced, and thus an output time can be reduced improving an operation speed in comparison with a related art in which a single amplifier amplifies whole voltage ranges. That is, since the display time can be reduced in comparison with a relate art, the image display delay can be prevented, the image display defect can be prevented, and a resolution of a displayable image can be improved.

Also, since an amplification voltage range of an amplifier is decreased, the circuit of an amplifier can be simply designed, and thus the size of an amplifier can be reduced.

Although the driver and the display device having the same have been described with reference to the specific embodiments, they are not limited thereto. Therefore, it will be readily understood by those skilled in the art that various modifications and changes can be made thereto without departing from the spirit and scope of the present invention defined by the appended claims.

What is claimed is:

1. A column driver, comprising:
a selection control unit configured to divide an n-bit image data into a k-bit sub data and an m-bit sub data such that k+m=n, and generate a selection control signal using the k-bit sub data and the m-bit sub data;
a counter configured to receive an image control signal and generate an m-bit data;
a conversion unit configured to receive the m-bit data from the counter and convert the m-bit data into a plurality of image data of different voltage levels; and
a selection unit configured to select and transfer output signals of the conversion unit in response to the selection control signal.

2. The column driver of claim 1, wherein the selection control unit comprises:
shift registers and latches configured to receive and latch the n-bit image data;
decoders configured to decode the k-bit sub data from the latched and outputted n-bit image data, and generate a plurality of output signals; and
comparators configured to compare the m-bit sub data from the latched and outputted n-bit image data with the m-bit data from the counter.

3. The column driver of claim 2, wherein the decoders and the comparators are configured in plural corresponding to the number of image data lines through which image data are supplied to a pixel.

4. The column driver of claim 3, further comprising a control unit configured to convert the n-bit data applied in series into a parallel data and apply the parallel data to the shift registers and latches.

5. The column driver of claim 2, wherein the conversion unit comprises:
at least one lookup table configured to store a modulation data set to convert gray-scaled image data, and to receive the m-bit data from the counter; and
a plurality of Digital to Analog Converters (DACs) configured to convert and amplify an image data whose gray level is changed according to the modulation data set stored in the lookup table to an analog signal, wherein the number of the DACs corresponds to the number of bits of the k-bit sub data,
wherein each of the DACs comprises an amplifier, and the amplifiers amplify voltages of different ranges.

6. The column driver of claim 5, wherein each of the amplifiers amplifies a divided voltage range from a maximum amplification voltage range, wherein a maximum amplification voltage of one amplifier is a starting amplification voltage of a next amplifier.

7. The column driver of claim 5, wherein the selection unit comprises:
a plurality of switch blocks configured to select an output signal of the DAC or the amplifier in response to the output signal of the decoder; and
a plurality of switches configured to respectively select signals transferred through the switch blocks in response to the output signal of the comparator.

8. The column driver of claim 7, wherein each of the switch blocks comprises a plurality of switches, whose number corresponds to the number of image data lines supplying image data to a pixel.

9. The column driver of claim 7, wherein the switch is configured in plural corresponding to the number of image data lines supplying image data to a pixel.

10. The column driver of claim 2, wherein the conversion unit comprises:
at least one lookup table configured to store a modulation data set to convert gray-scaled image data, and to receive the m-bit data from the counter;
a plurality of DACs configured to convert and amplify an image data whose gray level is changed according to the modulation data set stored in the lookup table to an analog signal, wherein the number of the DACs corresponds to the number of bits of the k-bit sub data; and
a plurality of amplifiers configured to amplify voltages of different ranges outputted from each of the DACs.

11. The column driver of claim 10, wherein each of the amplifiers amplifies a divided voltage range from a maximum amplification voltage range, wherein a maximum amplification voltage of one amplifier is a starting amplification voltage of a next amplifier.

12. The column driver of claim 10, wherein the selection unit comprises:
a plurality of switch blocks configured to select an output signal of the DAC or the amplifier in response to the output signal of the decoder; and
a plurality of switches configured to select signals transferred through the switch blocks in response to the output signal of the comparator.

13. The column driver of claim 12, wherein each of the switch blocks comprises a plurality of switches, whose number corresponds to the number of image data lines supplying image data to a pixel.

14. The column driver of claim 12, wherein the switch is configured in plural corresponding to the number of image data lines supplying image data to a pixel.

15. A column driver, comprising:
shift registers and latches configured to receive and latch an n-bit image data;
a plurality of decoders configured to decode a k-bit sub data from the latched n-bit image data, and generate a plurality of output signals;
a counter configured to receive an image control signal and generate an m-bit data;
a plurality of comparators configured to compare m-bit sub data from the latched and outputted n-bit image data such that k+m=n with the m-bit data from the counter;
at least one lookup table configured to store a modulation data set to convert gray-scaled image data;
a plurality of Digital to Analog Converters (DACs) configured to convert an image data whose gray level is changed according to the modulation data set stored in the lookup table to an analog signal, wherein the number of the DACs corresponds to the number of bits of the k-bit sub data;
a plurality of amplifiers configured to amplify voltages of different ranges outputted from each of the DACs; and
a selection unit configured to transfer output signals of the amplifiers in response to the output signals of the decoder and the comparator.

16. A display device, comprising:
a display panel comprising a display unit where a plurality of pixels are arranged in a matrix form, a row driver configured to supply a scanning signal to select a row of pixels, and a column driver configured to supply image data to the selected pixels in row; and
a display control unit configured to supply a control signal for driving the display panel and the image data,
wherein the column driver comprises:
a selection control unit configured to divide an n-bit image data into a k-bit sub data and an m-bit sub data such that k+m=n, and to generate a selection control signal using the k-bit sub data and the m-bit sub data;
a counter configured to receive an image control signal and generate an m-bit data;
a conversion unit configured to receive the m-bit data from the counter and convert the m-bit data into a plurality of image data of different voltage ranges; and
a selection unit configured to select and transfer an output signal of the conversion unit in response to the selection control signal.

17. The display device of claim 16, wherein the display unit, the row driver, and the column driver are provided on the same substrate.

18. The display device of claim 16, wherein the display unit is provided on a substrate, and the row driver and the column driver are connected to the display unit.

19. The display device of claim 16, wherein the display unit, the row driver, the column driver, and the display control unit are provided on the same substrate.

20. The display device of claim 16, wherein the row driver is provided at one side of the display unit, and the column driver is provided at the other side of the display unit intersecting the row driver at right angles.

21. The display device of claim 20, wherein the row driver is additionally provided at the opposite side of the said row driver across the display unit.

22. The display device of claim 20, wherein the column driver is additionally provided at the opposite side of the said column driver across the display unit.
